(19) United States
(12) Patent Application Publication
(10) Pub. No.: US 2026/0108854 A1
(43) Pub. Date: Apr. 23, 2026

(54) GRADIENT-CHARGE MEMBRANES FOR ACTIVE CO2 PUMPING AND METHOD FOR MAKING THE SAME

(71) Applicants: Arizona Board of Regents on Behalf of Arizona State University, Scottsdale, AZ (US); University College London, London (GB)

(72) Inventors: Matthew GREEN, Phoenix, AZ (US); Hoda SHOKROLLAHZADEH BEHBAHANI, Havertown, PA (US); Thomas MILLER, London (GB); Matthew TUDBALL, London (GB)

(21) Appl. No.: 19/366,371

(22) Filed: Oct. 22, 2025

Related U.S. Application Data
(60) Provisional application No. 63/710,191, filed on Oct. 22, 2024.

(51) Int. Cl. B01D 71/68; B01D 69/14

(52) U.S. Cl. CPC B01D 71/68; B01D 69/147; B01D 2313/243

(57) ABSTRACT

A membrane for active CO2 pumping and method for making the same is disclosed. The membrane includes a first polymer that is hydrophobic and unfunctionalized, and a second polymer having DAC functionalities. The membrane has a charged functionality gradient extending between two compositions. CO₂ is pumped continuously through the membrane by the charged functionality gradient when a moisture gradient is maintained across the membrane such that one side is drier than the other. The method for making the membrane includes dissolving the first and second polymers into first and second solutions, respectively, which are applied to a substrate as sprays to form first and second layers and a plurality of layers in between, while modifying a flow rate for the first and second solutions such that the layers together form the charged functionality gradient. The first and second polymers may be Udel polysulfone and PAES-co-QAPAES(50)[I], respectively.

### RELATED APPLICATIONS

This application claims the benefit of U.S. provisional patent application 63/710,191, filed Oct. 22, 2024 titled “Gradient Charge Membranes for Active CO₂ Pumping and Method for Making the Same,” the entirety of the disclosure of which is hereby incorporated by this reference.

### STATEMENT REGARDING FEDERALLY SPONSORED RESEARCH

This invention was made with government support under DE-SC0023343 and DE-AR0001103 awarded by the Department of Energy. The government has certain rights in the invention.

### TECHNICAL FIELD

Aspects of this document relate generally to membranes for active pumping of carbon dioxide.

### BACKGROUND

The rise of atmospheric carbon dioxide (CO₂) is a critical environmental challenge demanding innovative carbon capture and storage strategies. Atmospheric CO₂ reached 415 ppm in June 2021, correlating with global temperature increases, extreme weather, and wildfires. The IPCC predicts a 1.5° C. temperature rise within two decades even with major emission cuts; without intervention, temperatures could rise by 4.4° C., with catastrophic consequences. Global emissions are about 40 GT CO₂ annually, and roughly 1,000 GT must be removed this century to limit warming below 2° C. above pre-industrial levels.

Because CO₂ in ambient air is highly dilute, large-scale capture requires systems that are energy efficient, durable, and low-cost. Conventional systems tend to be expensive and mechanically fragile, making scalability difficult. Thus, simple and efficient designs are essential for practical deployment.

Modern direct air capture (DAC) technologies use sorbent materials to passively bind CO₂ from air and later release it for utilization or sequestration. Among these, moisture-swing sorbents are particularly effective. Under dry conditions, carbonate ions convert to bicarbonate and hydroxide, the latter enhancing CO₂ affinity. Exposure to moisture reverses this reaction, releasing CO₂ and regenerating the carbonate form. This humidity-driven cycle enables capture and release without high thermal energy input, reducing regeneration costs.

Conventional DAC systems making use of moisture-swing sorbent materials collect carbon dioxide in a batch process, gathering in one phase (e.g., dry) and releasing in another (e.g., wet). These batch processes that have traditionally been challenging to commercialize, for several reasons. The intermittent nature of the batch process makes it difficult to efficiently produce a continuous stream of concentrated CO2 that is ideal for many subsequent applications. Additionally, these batch processes require mechanisms to transition the system between the two phases. The required seals, valves, motors, pumps, doors, lifts, and the like, each introduce a new potential point of failure. These mechanisms can also increase the initial capital cost and/or operating cost for the system.

### SUMMARY

In some embodiments, a membrane for active carbon-dioxide (CO₂) pumping includes a first polymer and a second polymer, where the first polymer is hydrophobic and unfunctionalized and the second polymer includes direct-air-capture (DAC) functionalities together with DAC counter-ions associated with those functionalities. The membrane presents a first side opposite a second side and incorporates a charged-functionality gradient that extends across its thickness from a first composition adjacent the first side to a second composition adjacent the second side, with the first composition having a lower proportion of the second polymer than the second composition; when a moisture gradient is maintained across the membrane such that the first side is drier than the second side, the charged-functionality gradient drives pumping of CO₂ through the membrane from the first side toward the second side, and in some cases the CO₂ is pumped continuously. The DAC functionalities may include quaternary ammonium, pyridinium, phosphonium, or imidazolium cations, and the DAC counter-ions may include at least one of carbonate, bicarbonate, or hydroxide. In certain implementations, the first composition proximate the first side includes 0% of the second polymer and the second composition proximate the second side includes 100% of the second polymer; in other implementations, the first composition includes 5% of the second polymer and the second composition includes 100% of the second polymer. The second polymer may be PAES-co-QAPAES(50)[I], the first polymer may be Udel polysulfone, and the membrane may have a thickness of less than 36μm. In some embodiments, a method for fabricating a membrane for active CO₂ pumping includes dissolving a first polymer that is hydrophobic and unfunctionalized into a first solution and dissolving a second polymer into a second solution, where the second polymer includes DAC functionalities and original counter-ions; applying the first and second solutions to a substrate as sprays to form a first layer, a second layer, and a plurality of intermediate layers between the first and second layers while varying respective flow rates so that the stack of layers together defines a charged-functionality gradient extending from a first composition adjacent the first layer to a second composition adjacent the second layer, with the first composition having a lower proportion of the second polymer than the second composition; and removing the multilayer stack from the substrate to yield the membrane, where the first layer becomes a first side and the second layer becomes a second side of the membrane, such that when a moisture gradient is maintained across the membrane with the first side drier than the second side, the charged-functionality gradient drives continuous pumping of CO₂ from the first side to the second side. The method may further include exchanging the original counter-ions within the membrane with DAC counter-ions by exposing the membrane to a medium that contains the DAC counter-ions, wherein the second solution initially includes the original counter-ions; the substrate may be heated during deposition; and the first and second solutions may be applied to the substrate as sprays simultaneously. The DAC functionalities of the second polymer in the method may include quaternary ammonium, pyridinium, phosphonium, or imidazolium cations, and the DAC counter-ions introduced during exchange may include at least one of carbonate, bicarbonate, or hydroxide. In certain implementations of the method, the first composition formed adjacent the first layer includes 0% of the second polymer and the second composition formed adjacent the second layer includes 100% of the second polymer; in other implementations, the first composition formed adjacent the first layer includes 5% of the second polymer and the second composition formed adjacent the second layer includes 100% of the second polymer. The second polymer in the method may be PAES-co-QAPAES(50)[I], the first polymer may be Udel polysulfone, and the first and second solutions may be applied using at least one ultrasonic spray device.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors'intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . “or “step for performing the function of . . . , ” if the claims also recite any structure, material or acts in support of that means or step, or that perform the recited function, then it is the clear intention of the inventors not to invoke the provisions of 35 U.S. C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIG. 1A is a schematic cross-sectional view of a gradient-charge membrane for active CO₂ pumping;

FIG. 1B is a schematic cross-sectional view of a specific embodiment of a gradient-charge membrane for active CO₂ pumping;

FIG. 2 is a schematic process flow for a method for fabricating a gradient-charge membrane for active CO₂ pumping;

FIG. 3 is a schematic cross-sectional view of a counter-flow cell for characterizing a CO₂ pumping membrane; and

FIG. 4 shows a moisture gradient maintained for a specific embodiment of a gradient-charge membrane for active CO₂ pumping.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

The relentless rise of atmospheric carbon dioxide (CO₂) levels is a pressing environmental challenge, requiring innovative approaches to carbon capture and storage. The average CO₂ concentration in the atmosphere was 415 ppm in June 2021, which has been linked to elevated average global temperatures, extreme weather, wildfires, and more. The Intergovernmental Panel on Climate Change's 2021 report predicts a 1.5° C. rise in global temperature within the next two decades, assuming global policymakers aggressively reduce emissions. Without intervention, an average temperature rise of 4.4° C. is possible, leading to catastrophic results. Current CO₂ emissions are projected to reach 40 GT CO₂/year.

In addition to conservation, reduced-carbon processes, and on-site capture efforts, a significant amount of carbon dioxide will need to be removed from the atmosphere to avoid a looming climate change crisis. It is estimated that about 1,000 GT of CO₂ from the atmosphere needs to be removed by the end of the century in order to keep Earth below 2° C. of warming compared to before the Industrial Revolution.

Since the carbon dioxide in the ambient air is very dilute, atmospheric CO₂ collectors can quickly overrun a tight energy budget for drawing in and processing air in bulk. Additionally, conventional carbon dioxide collection systems often exhibit the unfortunate combination of being costly and fragile. Conventional capture devices also often have a large initial capital cost along with a high operating cost. As CO₂ capture will need to occur on a large scale, simple, efficient, low cost designs will play an important role in commercial application of atmospheric CO₂ capture technologies.

State of the art direct air capture devices can reduce the energy and financial cost, as well as the mechanical complexity and fragility, to a practical level. These devices can passively collect atmospheric carbon dioxide from the ambient air using sorbent materials that capture the carbon dioxide from the atmosphere and subsequently release it for use or sequestration.

One type of sorbent materials well adapted for use in direct air capture are moisture-swing sorbent materials. At low humidity levels, carbonate ions present on a moisture swing material react with the few remaining waters to form bicarbonate and hydroxide ions. This reaction is favored at low water content because the lack of water preferentially destabilizes the hydration cloud of the doubly charged carbonate ion. The presence of hydroxide attracts CO₂ and makes the dry material a strong sorbent for CO₂. Exposure to moisture re-stabilizes carbonate relative to bicarbonate. In the loaded bi-carbonate state, this transition destabilizes the bicarbonate and results in a much higher equilibrium partial pressure of CO₂. By harvesting the CO₂ gas, one can induce the material to fall back to the carbonate state. Subsequent drying will once again produce a bicarbonate/hydroxide mixture that will repeat the collection cycle.

The moisture swing method is advantageous compared to other methods because it has high selectivity and capacity for carbon capture and low regeneration costs. Because the sorbent's affinity to CO₂ changes through the interaction with moisture, the carbon can be released without the need of high thermal energy input.

Conventional DAC systems making use of moisture-swing sorbent materials collect carbon dioxide in a batch process, gathering in one phase (e.g., dry) and releasing in another (e.g., wet). These batch processes that have traditionally been challenging to commercialize, for several reasons. The intermittent nature of the batch process makes it difficult to efficiently produce a continuous stream of concentrated CO₂ that is ideal for many subsequent applications. Additionally, these batch processes require mechanisms to transition the system between the two phases. The required seals, valves, motors, pumps, doors, lifts, and the like, each introduce a new potential point of failure. These mechanisms can also increase the initial capital cost and/or operating cost for the system.

Contemplated herein is a gradient-charge membrane for active CO₂ pumping, and a method for making the same. This novel membrane has a unique design that incorporates a gradient of charged DAC functionalities (e.g. quaternary ammoniums) across its cross-section. This charged functionality gradient is engineered to facilitate the selective and efficient flux of CO₂ molecules through the membrane, from a dry side to a wet side, thus enabling continuous CO₂ removal from the environment.

The contemplated gradient-charge membrane exhibits a gradient of charged functionalities that can undergo moisture-swing CO₂ capture. A strategic arrangement of these charged functionalities creates a gradient. This gradient is crucial for driving the selective movement of CO₂ molecules from areas of high concentration to lower ones, enabling active and efficient pumping of CO₂. According to various embodiments, the gradient of charged (i.e., hydrophilic) to uncharged (i.e., hydrophobic) functionalities across the membrane thickness suppresses back diffusion of water while sustaining CO2 flux.

This design not only enables the CO₂ pumping process but also potentially reduces the energy consumption typically associated with continuous CO₂ removal technologies, according to various embodiments. According to various embodiments, the hydrophilic-to-hydrophobic functionality gradient maintains a moisture differential sufficient for continuous CO2 pumping without requiring mechanical switching or external heating.

Systems and devices using these gradient-charge membranes improve upon current direct air capture (DAC) technology by eliminating a great deal of equipment, moving parts, energy expenditure, and cost. Additionally, systems and devices using the CO₂ pump membranes contemplated herein do not require the use of strong sorbent liquids, and are thus relatively benign, posing little risk of releasing hazardous materials. The safe nature of these devices makes them well suited for unsupervised operation, even in an urban environment.

According to various embodiments, these gradient-charge membranes can provide a continuous stream of CO₂-rich product fluid. For some applications, such as applications with continuous processing or output, a continuous stream of carbon dioxide may be preferred over gas provided in batches due to cost and/or efficiency. Additionally, continuous capture systems and devices typically make use of structures and mechanisms that are much simpler than those used in cyclical or batched swing-based technology that must transition between capture and release phases. This may decrease the cost of manufacture, operation, and upkeep, and may allow the systems to operate unattended for longer periods of time.

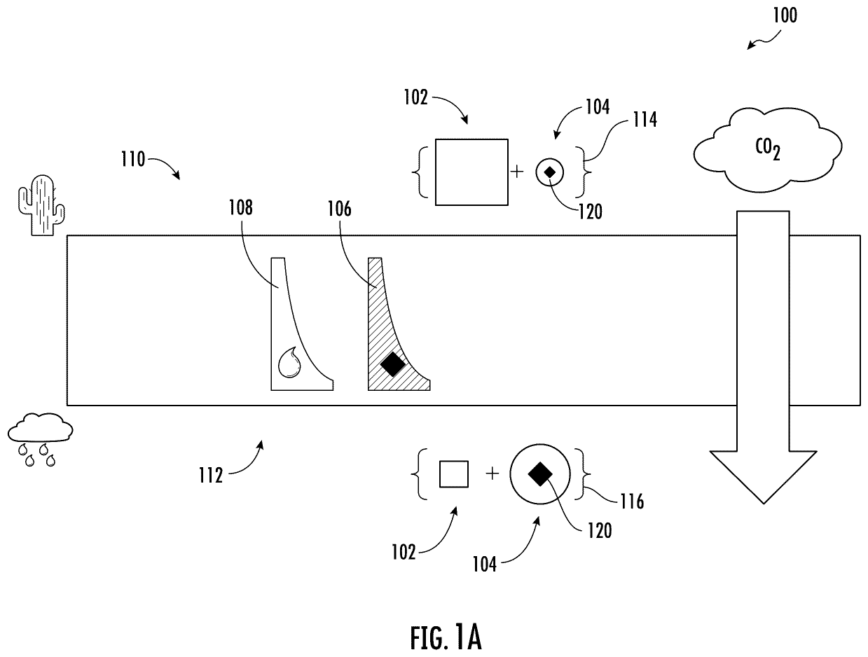

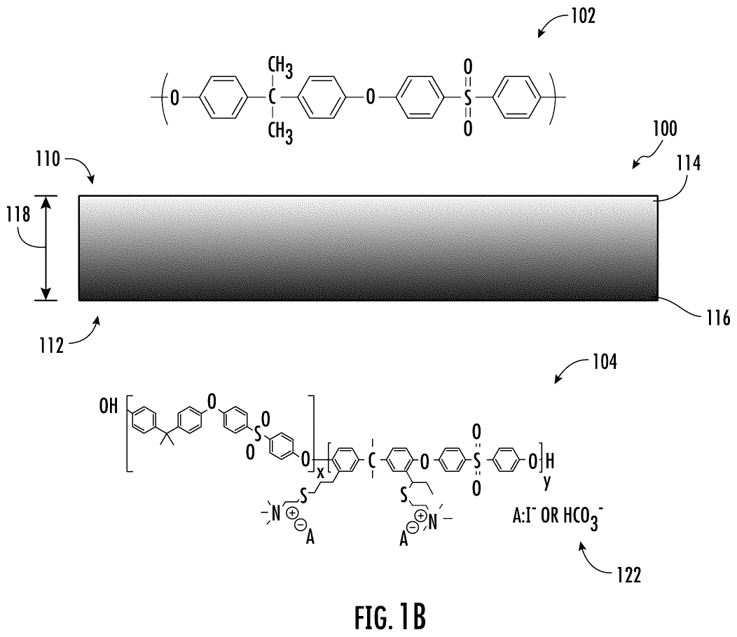

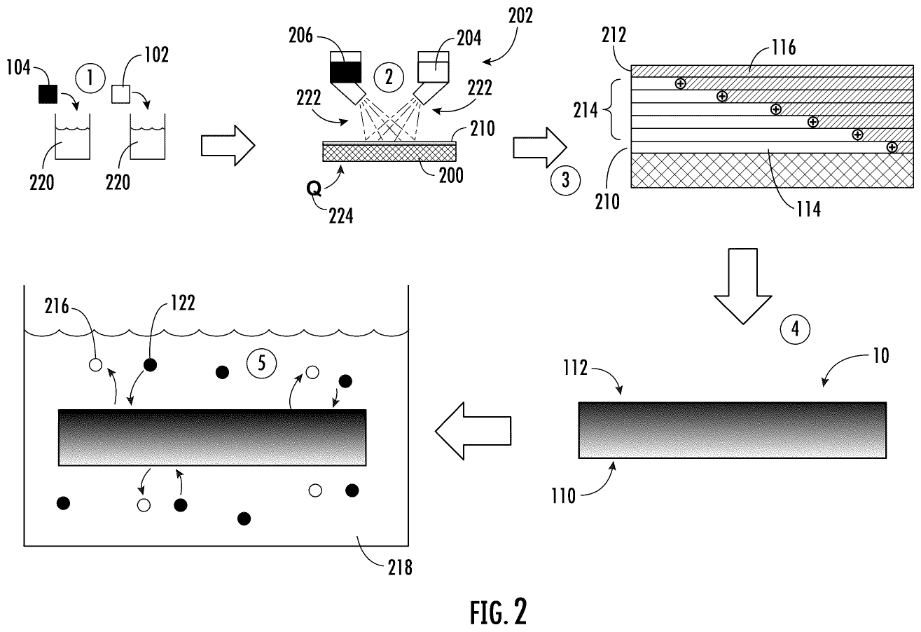

FIG. 1A is a schematic cross-sectional view of a non-limiting example of a gradient-charge membrane 100 for active CO₂ pumping. FIG. 1B is a schematic cross-sectional view of a specific embodiment of the gradient-charge membrane 100 shown in FIG. 1A. According to various embodiments, the gradient-charge membrane 100 (hereinafter membrane 100) contemplated herein is the combination of two polymers: a first polymer 102 that is hydrophobic and unfunctionalized (e.g., Udel polysulfone) and a second polymer 104 that is a DAC-functionalized polymer (e.g., PAES-co-QAPAES(50)[I]). According to various embodiments, these two polymers are combined in layers whose composition is modified such that a charged functionality gradient 106 is created. A method for making a gradient-charge membrane 100 will be discussed in greater detail with respect to FIG. 2, below.

The membrane 100 has a first side 110 and a second side 112 opposite the first side 110, giving it a cross-sectional thickness 118. According to various embodiments, the membrane 100 is a thin film. In some embodiments, the thickness 118 of the membrane 100 may be between 4 μm and 36 μm. In other embodiments, the membrane 100 may be thicker, while in still other embodiments the membrane 100 may be thinner than 4μm.

The first polymer 102 is hydrophobic and unfunctionalized. In the context of the present description and the claims that follow, an unfunctionalized first polymer 102 is lacking DAC functionalities and is not necessarily devoid of all functional groups. This makes it possible to form the charged functionality gradient 106 of DAC functionalities 120. As a specific example, in some embodiments including the non-limiting example shown in FIG. 1B, the first polymer 102 is Udel polysulfone.

The second polymer 104 of a gradient-charge membrane 100 comprises DAC functionalities 120 and DAC counterions 122 associated with those DAC functionalities 120. In the context of the present description and the claims that follow, a DAC functionality 120 is any chemical functionality or site, covalently or ionically associated with a material, that is capable of reversibly interacting with carbon dioxide under environmental or process conditions so as to facilitate its capture, transport, or release. Examples of DAC functionalities 120 include, but are not limited to, quaternary ammonium, pyridinium, phosphonium, and imidazolium cations.

Additionally, in the context of the present description and the claims that follow, a DAC counterion 122 being associated with the DAC functionalities 120 means counterions that are ionically or electrostatically coupled to, or otherwise present to maintain charge neutrality of, the DAC functionalities 120, whether directly bound, reversibly exchangeable, or mobile within the material's ionic network. Examples of DAC counterions 122 include, but are not limited to, carbonate, bicarbonate, and hydroxide.

As a specific example, in some embodiments including the non-limiting example shown in FIG. 1B, the second polymer 104 may be PAES-co-QAPAES(50)[I], a polymer synthesized with 50 mol% quaternary ammonium functionality neutralized with iodide counterions. Those iodide counterions may be exchanged with DAC counterions 122 (e.g., hydroxide) to give the second polymer 104 moisture-swing properties, as is known in the art. It should be noted that describing a completed gradient-charge membrane 100 as having PAES-co-QAPAES(50)[I] as a second polymer 104 (like some specific, non-limiting examples of the membrane 100 discussed herein) is not meant to imply an absence of DAC counterions 122. Indeed, it is the DAC counterions 122 that make the continuous CO₂ pumping across the membrane 100 possible, according to various embodiments.

As will be discussed in the context of FIG. 2, the contemplated gradient-charge membrane 100 is formed by combining the first polymer 102 and the second polymer 104 in stacked layers whose composition is varied such that the DAC functionalities 120 of the second polymer 104 form a charged functionality gradient 106. Specifically, the first polymer 102 and second polymer 104 are combined such that a charged functionality gradient 106 extends across the membrane 100 between a first composition 114 (i.e., the amount of one polymer relative to the other) adjacent the first side 110 and a second composition 116 adjacent the second side 112. As used herein, adjacent refers to being at, directly next to, or in contact with a surface or boundary of the membrane 100, such that no intervening functional layer of different composition separates the referenced region from that surface or boundary.

According to various embodiments, the charged functionality gradient 106 is formed because the first composition 114 has a lower proportion of the second polymer 104 than the second composition 116. For example, in one embodiment, the first composition 114 is 0% second polymer 104 and the second composition 116 is 100% second polymer 104. In another embodiment, the first composition 114 is 5% second polymer 104 and the second composition 116 is 100% second polymer 104. In a specific, non-limiting example, two different gradients 106 were created and will be discussed below: one with a gradient 106 of 0% (i.e., the first composition 114) to 100% (i.e., the second composition 116) PAES-co-QAPAES(50)[I] and another with a gradient 106 of 5% to 100% PAES-co-QAPAES(50)[I].

Achieving continuous CO₂ pumping across a membrane 100 utilizing moisture-swing based DAC functionalities 120 relies on the creation of a moisture gradient 108 across the membrane 100. This can be accomplished by keeping one side of the membrane 100 (i.e., the first side 110) dry and exposing the other side (i.e., the second side 112) to a fluid with higher moisture levels. Theoretically, CO₂ can be pumped from the dry side to the high moisture or “wet” side due to a gradient of these functionalities alone. However, DAC functionalities 120 are generally hydrophilic, which would facilitate the flow of water molecules across the membrane 100 in the opposite direction of the flow of CO₂ molecules. Such a counterflow would effectively halt potential CO₂ pumping. Addressing this by reducing the moisture gradient 108 across the membrane 100 to decrease water migration would result in reduced CO₂ flux due to fewer active sites. Advantageously, the contemplated membrane 100 features a charged functionality gradient 106 of DAC functionalities 120 across its cross-section that is balanced by a hydrophobic first polymer 102. The concentration of hydrophilic functionalities decreases and the relative concentration of the hydrophobic first polymer 102 increases when moving from the wet side (i.e., the second side 112) to the dry side (i.e., the first side 110), keeping the first side 110 drier than the second side 112 while also sustaining a significant moisture gradient 108 across the membrane 100 to enable CO₂ flux. For example, in one specific embodiment discussed below, a moisture gradient of 36 ppt is maintained across the membrane 100. In other words, the gradient of charged (i.e., hydrophilic) to uncharged (i.e., hydrophobic) functionalities across the membrane 100 cross section suppresses back diffusion of water while sustaining continuous CO₂ flux, according to various embodiments.

FIG. 2 is a schematic process flow for a non-limiting example of a method for making a gradient-charge membrane 100 for active CO₂ pumping. It should be noted that a specific embodiment may be discussed to illustrate an implementation of this method. It is a non-limiting example. Those skilled in the art will recognize various parts of this specific embodiment that may be accomplished using other methods or materials known in the art (e.g., the substrate material, etc.).

First, the first polymer 102 (i.e., a hydrophobic unfunctionalized polymer) and the second polymer 104 (i.e., a DAC-functionalized polymer) are each dissolved in a solvent 220 to create a first solution 204 and a second solution 206, respectively. See Step 1. In some embodiments, the second solution 206 may comprise original counterions 216 that will later be exchanged with DAC counterions 122. In some embodiments the first solution 204 and the second solution 206 may be separate dimethyl formamide (DMF) solutions. As a specific example, in one embodiment, these separate solutions are prepared at a concentration of 10 mg/ml. In other embodiments, a different solvent 220 may be used.

The first solution 204 and the second solution 206 are then applied to a substrate 200 to form layers. See Step 2. According to various embodiments, the first solution 204 and the second solution 206 may be applied to the substrate 200 as sprays 222 using at least one sprayer 202 (e.g., an ultrasonic spray device 208 such as a Sonotek Exactacoat ultrasonic spray coater).

The use of ultrasonic spraying allows for precise layering and control of the thickness and composition forming the membrane's charged functionality gradient 106, critical for maintaining the necessary moisture gradient 108 across the membrane 100 for effective CO₂ transport. Additionally, the use of ultrasonic spraying enables scalable and reproducible fabrication of membranes 100 with defined gradients.

In some embodiments, dual spray nozzles may be used to apply the first solution 204 and the second solution 206 to the substrate simultaneously. As a specific example, in one embodiment two nozzles were rotated at an angle of about 25° relative to one another and operated simultaneously, with the solution flow rates for each nozzle modified during the spraying process. Those skilled in the art will recognize that the technique may be further modified to achieve different gradients 106.

According to various embodiments, the substrate 200 provides a foundation on which the membrane 100 can be formed and from which the membrane 100 will later be removed. In some embodiments, the substrate 200 may be glass. Continuing with the specific example, in one embodiment the substrate is Pyrex glass. As an option, in some embodiments the substrate 200 may be heated before and/or during the application of the layers, to facilitate the complete evaporation of the solvent 220 used to make the first and second solutions (e.g., DMF). In the specific example, the Pyrex substrate 200 was heated to 175 °C.

It should be noted that while the present discussion is focused on the use of ultrasonic spray device(s) 208 to depose the layers that make up the membrane 100, other methods of deposing thin layers of material may be adapted for use in making the contemplated gradient-charge membrane 100, including methods not yet discovered. Ultrasonic spraying provides a number of attractive advantages, but should not be taken as the only way membrane 100 with a charged functionality gradient 106 can be formed.

The first solution 204 and the second solution 206 continue to be layered on the substrate 200 as sprays to form a first layer 210, a second layer 212, and a plurality of intermediate layers 214 between the first layer 210 and the second layer 212. See Step 3. It should be noted that although the terms “first layer” and “second layer” are being used, they are only meant to distinguish one from the other and are not intended to indicate that the initial layer deposed on the substrate 200 must have a particular composition or must ultimately become a particular side. For example, in the following discussion, the first layer 210 will be described as becoming the first side 110 of the resulting membrane 100; the first side 110 has consistently been described as the “dry” side (i.e., the side with the lowest second polymer 104 content) throughout this disclosure. However, this should not be interpreted as limiting the method for making the contemplated membrane 100 to always starting with the first composition 114 when deposing layers on the substrate 200. In some embodiments, the initial layer that is placed directly on the substrate 200 may have the first composition 114, while in other embodiments it may have the second composition 116.

According to various embodiments, the flow rates for the first solution 204 and the second solution 206 are modified such that the first layer 210, the intermediate layers 214, and the second layer 212 together form a charged functionality gradient 106 extending between a first composition 114 adjacent the first layer 210 and a second composition 116 adjacent the second layer 212, with the first composition 114 having a lower proportion of the second polymer 104 than the second composition 116.

In the specific example, the layers were sprayed to a size of 35 cm² at solution flow rates of up to 0.25 ml/min. The number of layers and solution flow rate may be adjusted to produce films with thicknesses of 4 μm up to approximately 36 μm, according to various embodiments.

Next, the membrane 100 made up of the first layer 210, the intermediate layers 214, and the second layer 212 is removed from the substrate 200. See Step 4. With the membrane 100 separated from the substrate 200, we will refer to the first layer 210 as the first side 110 and the second layer 212 as the second side 112 opposite the first side 110. Again, it is important to note that the distinguishing terms “first” and “second” are used here to consistently describe related aspects, and are not intended to imply or require a particular order (i.e., the first layer 210 does not have to be the initial layer deposed on the substrate, it could start with the second layer 212 and end on the first layer 210).

In some embodiments, the membrane 100 may already comprise DAC counterions 122 before it is separated from the substrate 200 (e.g., a counterion exchange was performed before layers were formed, the DAC counterions 122 were in the second solution 206, etc.). In other embodiments, including the non-limiting example shown in FIG. 2, counterions are exchanged after the membrane 100 is separated from the substrate 200. See Step 5. In some embodiments, the second solution 206 comprises original counterions 216 that remain in the membrane 100 after it is separated from the substrate 200. Those original counterions 216 are exchanged, within the membrane 100, with DAC counterions 122 through exposure to a medium 218 comprising the DAC counterions 122. According to various embodiments, the medium 218 may be a liquid, a vapor, or any other environment containing the new DAC counterions 122. This exchange activates the charge-gradient membrane 100 for reversible CO₂ sorption and desorption cycles.

In the specific example, inactive iodide counterions from PAES-co-QAPAES(50)[I] are exchanged with bicarbonate DAC counterions 122, providing moisture-swing DAC functionality. The membrane 100 is stirred in a 0.1 M potassium bicarbonate and deionized (DI) water solution at room temperature for 2 days to exchange the iodide counterions with bicarbonate counterions. Following the counterion exchange, the excess ions were washed away by placing the membrane 100 in fresh DI water at room temperature for 2 days, with the DI water being replaced once per day.

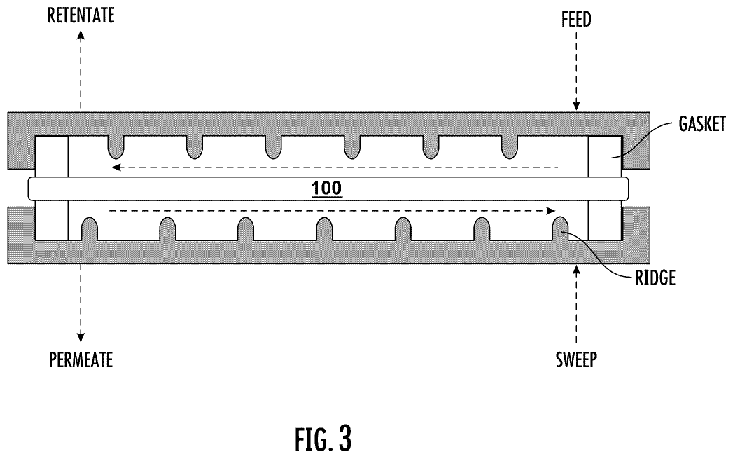

FIG. 3 is a schematic cross-sectional view of a non-limiting example of a counter-flow cell designed for observing and characterizing a CO₂ pumping membrane 100. The membrane 100 can be positioned inside a co-current or counter-current cell, with one side exposed to dry air and the other to a humid stream. Here, gaskets and brash sheets can be utilized to adjust the window of membrane 100 being studied for CO₂ pumping. Ridges may be utilized to minimize the influence of the potential polarization layers, according to various embodiments.

The DAC functionalities of the membrane 100 enable the continuous removal of CO₂ from the dry side (i.e., the first side 110) to the wet side (i.e., the second side 112), allowing it to permeate through the membrane 100. Subsequently, the CO₂ is desorbed into the high-moisture stream. The charged functionality gradient 106 within the membrane 100 is crucial for maintaining the necessary moisture gradient 108 across it, with the hydrophobic properties of Udel polysulfone assisting in this process. Without this gradient 106, water could migrate from the humid stream to the dry side at a high flux, opposing the CO₂ flow and hindering the movement of CO₂ molecules. The inlet and outlet on both sides of the membrane 100 are connected to 4 infrared gas analyzers (IRGA), allowing for precise measurement of CO₂ content in parts per million (ppm) and H₂O levels in parts per thousand (ppt). This setup enables continuous monitoring and validation of the membrane 100's performance in real-time.

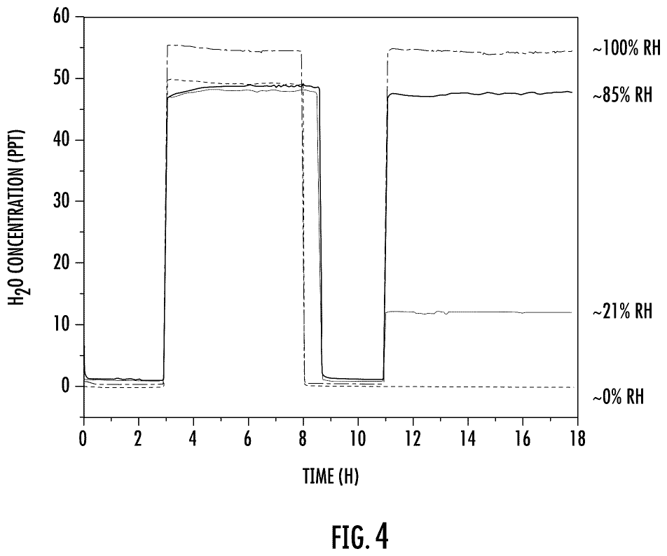

FIG. 4 shows a moisture gradient 108 maintained for a specific embodiment of a gradient-charge membrane 100, specifically a membrane 100 with a charged functionality gradient 106 of 100% to 5% PAES-co-QAPAES(50)[I]. This film, with a membrane thickness 118 of 36 μm and a tested membrane area of approximately 2.8 cm², demonstrates effective performance at a temperature of 35° C. A constant 64% RH, which corresponds to ˜36 ppt of effective moisture gradient 108 (or net humidity difference across the membrane 100) is observed across this membrane 100, when one side is kept dry (i.e., 0 ppt moisture) and the other is at 100% RH.

It will be understood that implementations of the gradient-charge membrane 100 include but are not limited to the specific components disclosed herein, as virtually any components consistent with the intended operation of various CO₂ pump membranes 100 may be utilized. Accordingly, for example, it should be understood that, while the drawings and accompanying text show and describe particular gradient-charge membrane 100 implementations, any such implementation may comprise any shape, size, style, type, model, version, class, grade, measurement, concentration, material, weight, quantity, and/or the like consistent with the intended operation of a CO₂ pump membrane 100.

The concepts disclosed herein are not limited to the specific gradient-charge membranes 100 shown herein. For example, it is specifically contemplated that the components included in particular gradient-charge membranes 100 may be formed of any of many different types of materials or combinations that can readily be formed into shaped objects and that are consistent with the intended operation of the gradient-charge membrane 100.

In places where the description above refers to particular gradient-charge membrane 100 implementations, it should be readily apparent that a number of modifications may be made without departing from the spirit thereof and that these implementations may be applied to other implementations disclosed or undisclosed. The presently disclosed gradient-charge membranes 100 are, therefore, to be considered in all respects as illustrative and not restrictive.

What is claimed is:

1. A membrane for active CO₂ pumping, comprising:
a first polymer that is hydrophobic and unfunctionalized;
a second polymer comprising DAC functionalities and DAC counterions associated with the DAC functionalities;
a first side opposite a second side; and
a charged functionality gradient extending across the membrane between a first composition adjacent the first side and a second composition adjacent the second side, the first composition having a lower proportion of the second polymer than the second composition;
wherein CO₂ is pumped through the membrane from the first side to the second side by the charged functionality gradient when a moisture gradient is maintained across the membrane such that the first side is drier than the second side.

2. The membrane of claim 1, wherein the DAC functionalities comprise one of quaternary ammonium, pyridinium, phosphonium, and imidazolium cations.

3. The membrane of claim 1, wherein the DAC counterions comprise at least one of carbonate, bicarbonate, and hydroxide.

4. The membrane of claim 1, wherein the first composition is 0% second polymer and the second composition is 100% second polymer.

5. The membrane of claim 1, wherein the first composition is 5% second polymer and the second composition is 100% second polymer.

6. The membrane of claim 1, wherein the second polymer is PAES-co-QAPAES(50)[I].

7. The membrane of claim 1, wherein the first polymer is Udel polysulfone.

8. The membrane of claim 1, wherein the membrane has a thickness less than 36 μm.

9. The membrane of claim 1, wherein the CO₂ is pumped continuously through the membrane from the first side to the second side.

10. A method for fabricating a membrane for active CO₂ pumping, comprising:
dissolving a first polymer that is hydrophobic and unfunctionalized into a first solution;
dissolving a second polymer into a second solution, the second polymer comprising DAC functionalities and original counterions;
applying the first solution and the second solution to a substrate as sprays to form a first layer, a second layer, and a plurality of intermediate layers between the first layer and the second layer, while modifying a flow rate for the first solution and the second solution such that the first layer, the intermediate layers, and the second layer together form a charged functionality gradient extending between a first composition adjacent the first layer and a second composition adjacent the second layer, the first composition having a lower proportion of the second polymer than the second composition; and
removing from the substrate the first layer, the intermediate layers, and the second layer that together form the membrane, the membrane having a first side opposite a second side, the first side being the first layer and the second side being the second layer;
wherein CO₂ is pumped continuously through the membrane from the first side to the second side by the charged functionality gradient when a moisture gradient is maintained across the membrane such that the first side is drier than the second side.

11. The method of claim 10, further comprising:
exchanging original counterions within the membrane with DAC counterions through exposure to a medium comprising the DAC counterions;
wherein the second solution comprises original counterions.

12. The method of claim 10, further comprising heating the substrate.

13. The method of claim 10, wherein the first solution and the second solution are applied to the substrate as sprays simultaneously.

14. The method of claim 10, wherein the DAC functionalities comprise one of quaternary ammonium, pyridinium, phosphonium, and imidazolium cations.

15. The method of claim 11, wherein the DAC counterions comprise at least one of carbonate, bicarbonate, and hydroxide.

16. The method of claim 10, wherein the first composition is 0% second polymer and the second composition is 100% second polymer.

17. The method of claim 10, wherein the first composition is 5% second polymer and the second composition is 100% second polymer.

18. The method of claim 10, wherein the second polymer is PAES-co-QAPAES(50)[I].

19. The method of claim 10, wherein the first polymer is Udel polysulfone.

20. The method of claim 10, wherein the first solution and the second solution are applied to the substrate using at least one ultrasonic spray device.
